(19) United States
(12) Patent Application Publication
(10) Pub. No.: US 2010/0097559 A1
(43) Pub. Date: Apr. 22, 2010

(54) SIMPLE MATRIX VERTICAL ALIGNMENT MODE LIQUID CRYSTAL DISPLAY DEVICE WITH LINEAR WALL LAYERS

(75) Inventor: Masatoshi HORII, Yokohama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Stanley Electric Co., Ltd., Tokyo (JP)

(21) Appl. No.: 12/571,569

(22) Filed: Oct. 1, 2009

(30) Foreign Application Priority Data
Oct. 17, 2008 (JP) 2008-268438

(51) Int. Cl. G02F 1/1343

(52) U.S. Cl. 349/147

(57) ABSTRACT

In a simple matrix vertical alignment mode liquid crystal display device including first and second substrates opposing each other, a first electrode layer including a plurality of first electrodes provided at an inner side of the first substrate, a second electrode layer including a plurality of second electrodes provided at an inner side of the second substrate, and a vertical alignment mode liquid crystal layer provided between the first and second substrates, a plurality of linear wall layers are provided between the first and second substrates in parallel with the first electrodes.

This application claims the priority benefit under 35 U.S.C. §119 to Japanese Patent Application No. JP2008-268438 filed on Oct. 17, 2008, which disclosure is hereby incorporated in its entirety by reference.

### BACKGROUND

1. Field

The presently disclosed subject matter relates to a simple matrix vertical alignment mode liquid crystal display (LCD) device.

2. Description of the Related Art

In a prior art simple matrix vertical alignment mode

LCD device, since liquid crystal molecules are vertically aligned with respect to substrates while applying no voltage thereto, the black representation is excellent. Also, when an optical compensation plate or a retardation film having a negative optical isomer property is introduced onto one or both polarizers, the viewing angle properties are very excellent (see: JP2005-234254A).

Also, a rubbing aligning process or an ultraviolet ray aligning process is performed upon alignment layers, to thereby realize a mono-domain alignment in a vertical alignment mode liquid crystal layer. On the other hand, slits are provided on electrode layers or ridges are provided on substrates, to thereby realize a multi-domain alignment in a vertical alignment mode liquid crystal layer. Particularly, the above-mentioned mono-domain aligning process can make the alignment state of the vertical alignment mode liquid crystal layer uniform regardless of whether or not a voltage is applied thereto.

Further, in order to avoid alignment defects in the vertical alignment mode liquid crystal layer while applying a voltage thereto, a pretilt angle is allocated so that liquid crystal molecules in the vertical alignment mode liquid crystal layer are tilted a little from a vertical angle)(90° with respect to the substrates while applying no voltage thereto.

In the above-described prior art simple matrix vertical alignment mode LCD device without requiring thin film transistors (TFTs), a multiplexing driving is used. A typical multiplexing driving is based on an optimal bias method whose driving waveforms are an in-frame-reversal driving waveform or a line-reversal driving waveform (hereinafter, referred to as an A-waveform), a frame-reversal driving waveform (hereinafter, referred to as a B-waveform), and a multi-line-reversal driving waveform (hereinafter, referred to as a C-waveform). Note that the B-waveform is now often used in view of the small power consumption.

In the above-described prior art simple matrix vertical alignment mode LCD device, however, since the anchoring force of the direction of the azimuth of liquid crystal on the plane of the substrates is weaker as compared with that of a horizontal alignment mode LCD device such as a twisted nematic-mode (TN-mode) LCD device, when the direction of the azimuth of liquid crystal on the plane of the substrates is deviated by some external factors from a direction set by an alignment process, the retardation would be partly changed, so that a low transmittivity region would be visible as a “black shadow region” within a white pixel (dot) of the vertical alignment mode liquid crystal layer while applying a voltage thereto. Also, if the viewing angle is changed, the black shadow region would be visible as a “rough region”. Further, if one black shadow region within one white dot reaches another black shadow region of its adjacent white dot, a plurality of black shadow regions are visible as an “irregularly-continuous region” within continuous white dots. The phenomenon of such a black shadow region, a rough region and an irregularly-continuous region is called a dynamic misalignment (DMA) phenomenon which would not only decrease the uniformity of representation of dots, but would drop patterns represented by dots.

The generation state of the above-mentioned DMA phenomenon may be changed due to various internal factors such as a pretilt angle affecting the anchoring force of the azimuth of the direction of liquid crystal on the plane of the substrates and the frame response phenomenon of liquid crystal.

Also, the generation state of the above-mentioned DMA phenomenon may be changed due to some external factors. One of the external factors is an oblique electric field generated between electrode layers, i. e., a segment electrode layer and a common electrode layer. In more detail, an oblique electric field is generated between an edge of one segment electrode of the segment electrode layer and an even portion of one common electrode of the common electrode layer. Similarly, an oblique electric field is generated between an edge of one common electrode of the common electrode layer and an even portion of one segment electrode of the segment electrode layer. Particularly, the generation state of the DMA phenomenon in the vertical alignment mode LCD device is strongly affected by the above-mentioned oblique electric field. That is, since the liquid crystal in the vertical alignment mode LCD device is of a negative type, the director of liquid crystal can easily fall along a direction perpendicular to an electric line of force of an electric field applied thereto, so that the director of liquid crystal easily falls along a direction perpendicular to an electric line of force of the above-mentioned slant electric field. Therefore, if the director of liquid crystal is different from a director of liquid crystal set by an alignment process, a black shadow region would be visible between the boundaries of the segment and common electrodes.

In the above-described prior art simple matrix vertical alignment mode LCD device, since the pretilt angle is around 90° so that the anchoring force of liquid crystal along the direction of the azimuth thereof on the plane of the substrates is very small, and also, the liquid crystal is in a high response speed state, the liquid crystal is easily moved along the direction of the azimuth thereof on the plane of the substrates. That is, the above-mentioned high pretilt angle is required to improve the sharpness for high viewing angle properties at a high duty ratio driving operation. Also, the above-mentioned high response speed state can be realized by the low viscosity of liquid crystal, a thin thickness of a liquid crystal layer, a high operational temperature and so on. As a result, a director of liquid crystal would be generated from a start position where an oblique electric field whose direction is different from the direction of the azimuth of liquid crystal set by the alignment process is generated along a direction different from the direction of azimuth of liquid crystal set by an alignment process. In this case, liquid crystal molecules have forces to make them parallel with each other, and the anchoring force of liquid crystal along the direction of the azimuth thereof on the plane of the substrates is very small, as stated above, a black shadow region where deviated directors of liquid crystal are spread gradually from the above-mentioned start position to its peripheral positions. Thus, a large number of directors of liquid crystal are deviated from the alignment direction set by the alignment process.

In order to avoid the generation of the above-mentioned black shadow region, one approach is to suppress the frame response phenomenon. That is, a high frequency driving method increasing the frame frequency and using the A-waveform, the C-waveform or a multi-line addressing (MLA) waveform is carried out to decrease a pulse interval by a multiplexing driving. However, this high frequency driving method would increase the power consumption and also, would increase the crosstalk phenomenon by resistance components of the electrode layers.

### SUMMARY

The presently disclosed subject matter seeks to solve one or more of the above-described problems.

According to the presently disclosed subject matter, in a simple matrix vertical alignment mode LCD device including first and second substrates opposing each other, a first electrode layer including a plurality of first electrodes provided at an inner side of the first substrate, a second electrode layer including a plurality of second electrodes provided at an inner side of the second substrate, and a vertical alignment mode liquid crystal layer provided between the first and second substrates, a plurality of first linear wall layers are provided between the first and second substrates in parallel with the first electrodes.

Also, a plurality of second linear wall layers are provided between the first and second substrates in parallel with the second electrodes.

The inventor has found that, in a simple matrix vertical alignment mode LCD device, the DMA phenomenon of one pixel (dot) would affect its adjacent pixels (dots).

For example, assume that the first electrode layer, the first electrodes, the second electrode layer and the second electrodes are a common electrode layer, common electrodes, a segment electrode layer and segment electrodes, respectively. In this case, the inventor has found that, when the common electrodes are sequentially scanned in a scanning direction, a DMA phenomenon generated below the final common electrode would be propagated in a reverse direction of the scanning direction. This is considered to be because a director of liquid crystal would be propagated in the scanning direction. The propagation of the DMA phenomenon in the scanning direction can be suppressed by the first linear wall layers.

Similarly, a DMA phenomenon generated by driving the segment electrode may be propagated in a direction perpendicular thereto. The propagation of the DMA phenomenon in the direction perpendicular to the segment electrodes can be suppressed by the second linear wall layers.

According to the presently disclosed subject matter, the propagation of the DMA phenomenon can be suppressed by the linear wall layers in parallel with the first and/or second electrodes. Also, since a high frequency driving is unnecessary, the power consumption can be decreased and also, the crosstalk can be decreased. Further, since the DMA phenomenon in a high temperature region can be decreased, the operational margin can be broadened. Furthermore, since the pretilt angle can be increased, the sharpness, i.e., the contrast can be improved and, also, the viewing angle properties can be improved.

### BRIEF DESCRIPTION OF THE DRAWINGS

The above and other advantages and features of the presently disclosed subject matter will be more apparent from the following description of certain embodiments, as compared with the prior art, taken in conjunction with the accompanying drawings, wherein:

FIG. 1 is a panel layout diagram illustrating a prior art simple matrix vertical alignment mode LCD device;

FIG. 2 is a cross-sectional view taken along the line II-II in FIG. 1;

FIG. 3 is a microscopic picture diagram for explaining the experimental results obtained by driving the simple matrix vertical alignment mode LCD device of FIGS. 1 and 2;

FIG. 4 is a panel layout diagram illustrating a first embodiment of the single matrix vertical alignment mode LCD device according to the presently disclosed subject matter;

FIG. 5 is a cross-sectional view taken along the line V-V in FIG. 4;

FIGS. 6A, 6B, 7 and 8 are microscopic picture diagrams for explaining the experimental result obtained by driving the simple matrix vertical alignment mode LCD device of FIGS. 4 and 5;

FIGS. 9 and 10 are cross-sectional views illustrating modifications of the simple matrix vertical alignment mode LCD device of FIG. 5;

FIG. 11 is a panel layout diagram illustrating a second embodiment of the single matrix vertical alignment mode LCD device according to the presently disclosed subject matter;

FIG. 12 is a cross-sectional view taken along the line XII-XII in FIG. 11; and

FIG. 13 is a microscopic picture diagram for explaining the experimental results obtained by driving the simple matrix vertical alignment mode LCD device of FIGS. 11 and 12.

### DETAILED DESCRIPTION OF EXEMPLARY EMBODIMENTS

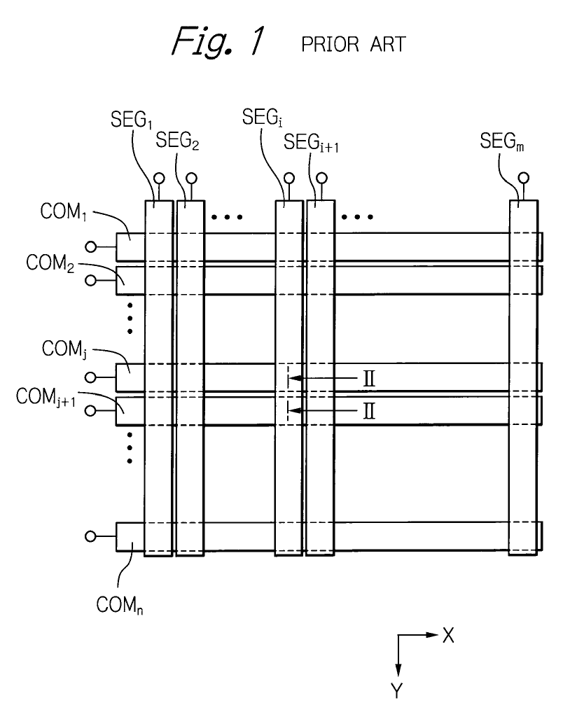

Before the description of exemplary embodiments, a prior art simple matrix vertical alignment mode LCD device will now be explained with reference to FIGS. 1, 2 and 3.

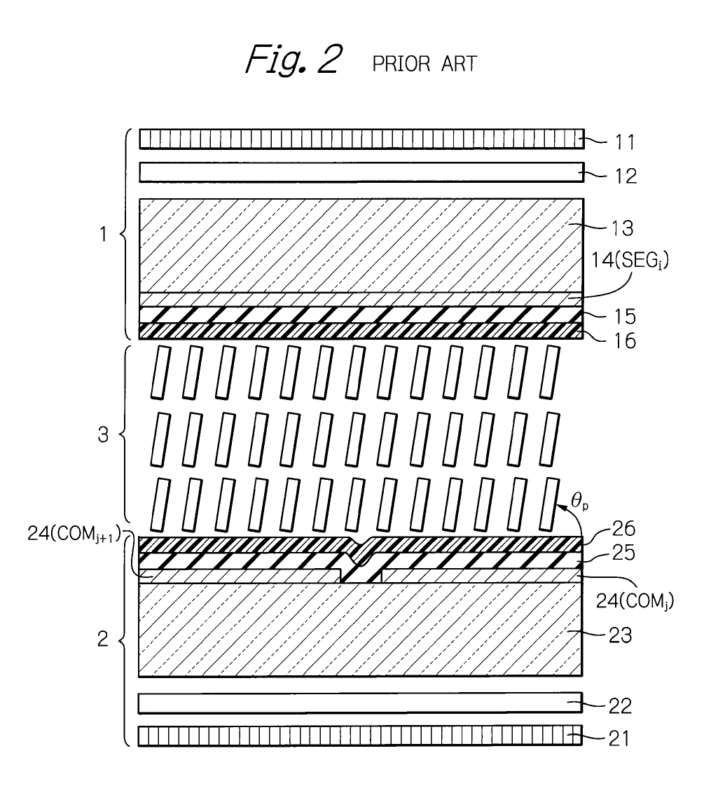

In FIG. 1, which illustrates a prior art simple matrix vertical alignment mode LCD device, segment electrodes SEG₁, SEG₂, . . . , SEGᵢ, SEGᵢ₊₁, . . . , SEGₘ as signal lines extending along a Y direction are arranged in parallel along an X direction. Similarly, common electrodes COM₁, COM₂, . . . , COMⱼ, C)Mⱼ₊₁, . . . , COMₙ as scan lines extending along the X direction are arranged in parallel along the Y direction. For example, a transparent segment electrode layer 14 (see: FIG. 2) forming the segment electrodes SEG₁, SEG₂, SEGᵢ₊₁, . . . , SEGₘ is positioned at an upper level, while a transparent common electrode layer 24 (see: FIG. 2) forming the common electrodes COM₁, COM₂, . . . . , COMⱼ, COMⱼ₊₁, . . . , COMₙ is positioned at a lower level, thus forming m×n pixels (dots) between the segment electrode layer 14 and the common electrode layer 24. In the segment electrodes SEG₁, SEG₂, . . . , SEGᵢ, SEGᵢ₊₁, . . . , SEGₘ and the common electrodes COM₁, COM₂, . . . , COMⱼ, COMⱼ₊₁, . . . , COMₙ, the line-width is about 405 μm and the spacing is about 30 μm.

Referring to FIG. 2, which is a cross-sectional view taken along the line II-II in FIG. 1, an upper structure 1 includes the transparent segment electrode layer 14, and a lower structure 2 includes the transparent common electrode layer 24. Also, a vertical alignment mode liquid crystal layer 3 is interposed between the upper structure 1 and the lower structure 2.

The upper structure 1 is formed by a polarizer 11, an optical compensation plate 12, a glass substrate 13, the above-mentioned transparent segment electrode layer 14, an insulating layer 15 and a vertical alignment layer 16. Similarly, the lower structure 2 is formed by a polarizer 21, an optical compensation plate 22, a glass substrate 23, the above-mentioned transparent common electrode layer 24, an insulating layer 25 and a vertical alignment layer 26.

The polarizers 11 and 21 are made of iodine-including material or dye-including material such as SHC-13U (trademark) by Polatechno, Japan. The polarizers 11 and 21 cross at 90°. In this case, the angles of the polarizers 11 and 21 are +45° and −45°, respectively, with respect to the set director of liquid crystal of the vertical alignment mode liquid crystal layer 3 to form a crossed Nicols combination, so that a change of the difference in phase while applying a voltage thereto is maximum. Note that the crossing angle of the polarizers 11 and 21 may be deviated by a few degrees from 90°. The director of liquid crystal is in an upper direction (12 am direction) or in a lower direction (6 am direction) viewed from the top, thus obtaining a broad viewing angle representation having symmetrical viewing angle properties.

Each of the optical compensation plates 12 and 22 is a uniaxial retardation plate which is constructed by a so-called negative C-plate where the in-plane retardation value Δ R is 0 nm and the thickness direction retardation value Δₜₕ is 220 nm. An A-plate or a biaxial retardation plate called a B-plate may be used instead of the C-plate.

The transparent segment electrode layer 14 and the transparent common electrode layer 24 are made of indium tin oxide (ITO) or the like.

The insulating layers 15 and 25 are used for electrically-isolating the transparent segment electrode layer 14 and the transparent common electrode layer 24, respectively, so as to prevent a short-circuited state between the electrode layers 14 and 24 due to a foreign substance within the vertical alignment mode liquid crystal layer 3.

The vertical alignment layers 16 and 26 are made of polyimide or inorganic material. The alignment treatment of the vertical alignment layers 16 and 26 is carried out by a protrusion alignment process, a rubbing alignment process or an ultraviolet ray alignment process. For example, a polyimide layer is coated by a flexographic printing process and then is cured. Then, a rubbing alignment process is carried out to give a pretilt angle θₚ of 89.5° or 89.9°. In this case, the direction of the pretilt angle of the vertical alignment layer 26 is 90° in the counterclockwise rotation with respect to the right direction)(=0°, while the direction of the pretilt angle of the vertical alignment layer 16 is 90° in the clockwise rotation with respect to the right direction) (=0°, thus realizing an anti-parallel alignment.

The vertical alignment mode liquid crystal layer 3 is of a negative type where the dielectric anisotropy Δ ε is −2.6 and the optical anisotropy Δ n is 0.20. The thickness of the vertical alignment mode liquid crystal layer 3 is about 2.0 μm. A chiral agent can be added to the vertical alignment mode liquid crystal layer 3 to avoid the reverse twist phenomenon, thereby realizing a twist structure.

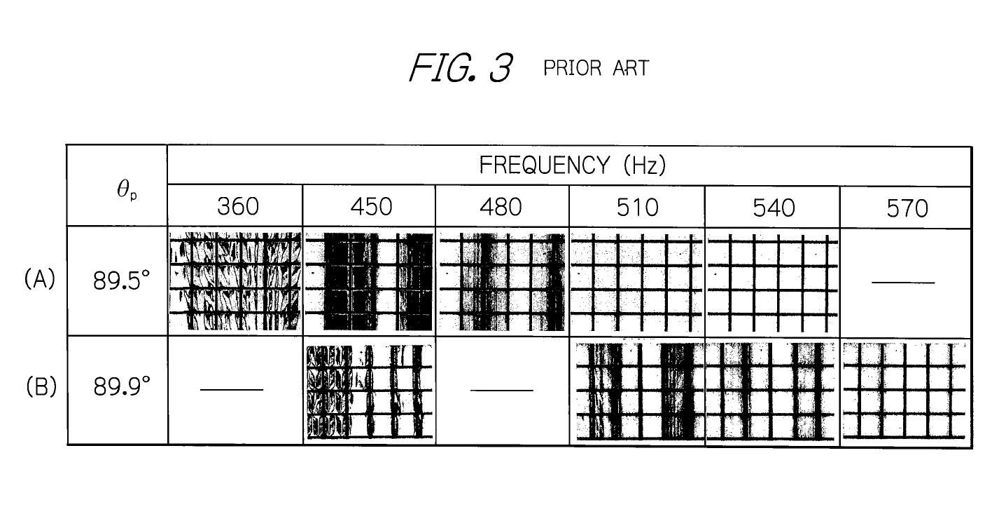

The experimental results of the simple matrix vertical alignment mode LCD device of FIGS. 1 and 2 driven by using the B-waveform at a 1/64 duty ratio and a bias of 1/9 are illustrated in FIG. 3.

As illustrated in FIG. 3(A), when θₚ=89.5°, black shadow regions by the DMA phenomenon were visible for 480 Hz or less, while no black shadow regions were visible for 510 Hz or more, to realize an excellent transmission state of white dots.

Also, as illustrated in FIG. 3(B), when θₚ=89.9°, black shadow regions by the DMA phenomenon were visible for 540 Hz or less, while no black shadow regions were visible for 570 Hz or more, to realize an excellent transmission state of white dots.

Thus, the higher the pretilt angle θₚ, the more visible the black shadow regions caused by the DMA phenomenon.

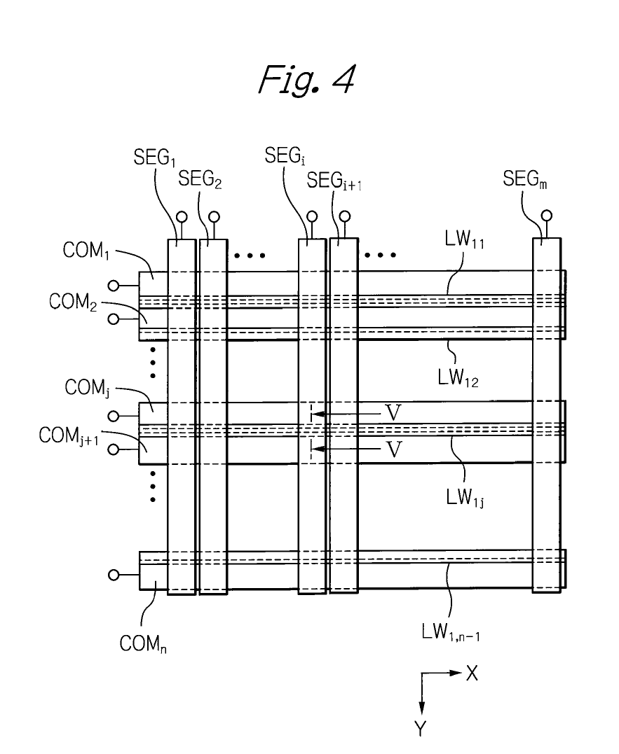

In FIG. 4, which illustrates a first embodiment of the single matrix vertical alignment mode LCD device according to the presently disclosed subject matter, linear wall layers LW₁₁, LW₁₂, . . , LW₁ⱼ, . . . , LW_{1, n-1} are formed in parallel with the common electrodes COM₁, COM₂, . . . , COMⱼ, COMⱼ₊₁, . . . , COMₙ. In this case, the linear wall layers LW₁₁, LW₁₂, . . . , LW₁ⱼ, . . . , LW_{1, n-1} are formed at certain spacings between the common electrodes COM₁, COM₂, . . . . , COMⱼ, COMⱼ₊₁, . . . , COMₙ to minimize the liquid crystal transmission ratio, i.e., the aperture ratio of the vertical alignment mode liquid crystal layer 3.

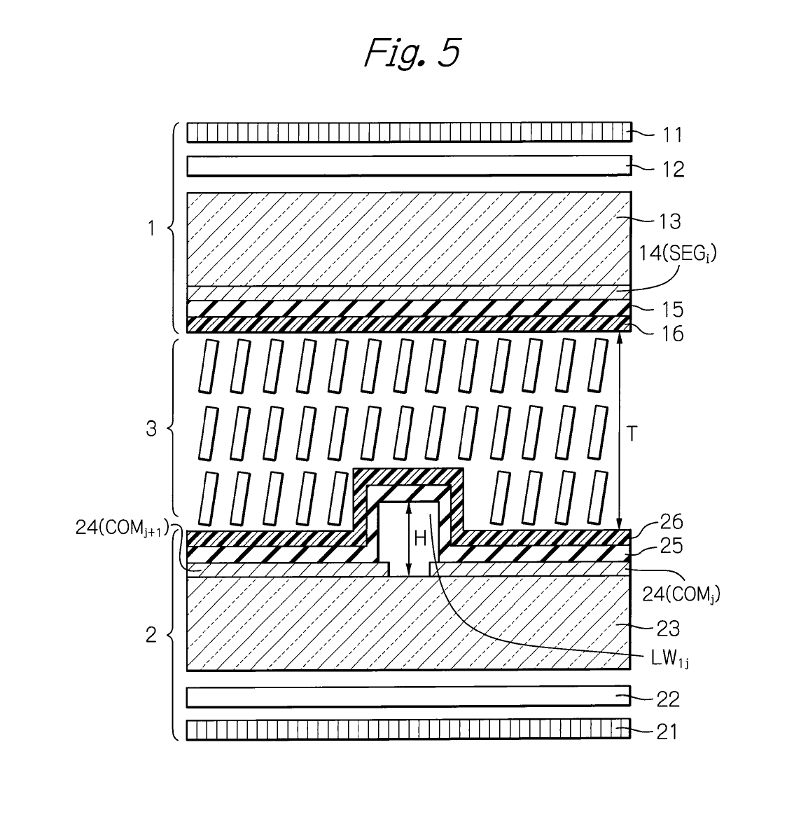

Referring to FIG. 5, which is a cross-sectional view taken along the line V-V in FIG. 4, the linear wall layer LW₁ⱼ, which is about 50 μm wide, is formed with certain spacings between the common electrode COMⱼ and the common electrode COMⱼ₊₁ of the transparent common electrode layer 24 whose spacing is about 30 μm, so that the linear wall layer LW₁ⱼ overlaps the common electrode COMⱼ and the common electrode COMⱼ₊₁. Also, a height H of the linear wall layer LW₁ⱼ is

H≧T/2

where T is a thickness of the vertical alignment mode liquid crystal layer 3. Note that thicknesses of the electrode layers 14 and 24, the insulating layers 15 and 25 and the vertical alignment layers 16 and 26 are much smaller than the thickness T of the vertical alignment mode liquid crystal layer 3; however, these thicknesses are exaggeratedly illustrated for better understanding.

The linear wall layers LW₁₁, LW₁₂, . . . , LW₁ⱼ, . . . , LW_{1, n-1} may be transparent or opaque (black matrix). For example, an ultraviolet ray hardening resin is coated thereon, and then the ultraviolet ray hardening resin is patterned by a photolithography process. Note that, if the linear wall layers LW₁₁, LW₁₂, . . . , LW₁ⱼ, . . . , LW_{1,n-1} are deviated from the spacings between the common electrodes COM₁, COM₂, . . . , COMⱼ, COMⱼ₊₁, . . . , COMₙ, the line-width of the linear wall layers LW₁₁, LW₁₂, . . . , LW₁ⱼ, . . . , LW_{1, n-1} is decreased to a value of the spacing of the common electrodes COM₁, COM₂, . . . , COMⱼ, COMⱼ₊₁, . . . , COMₙ, to thereby minimize the reduction of the aperture ratio.

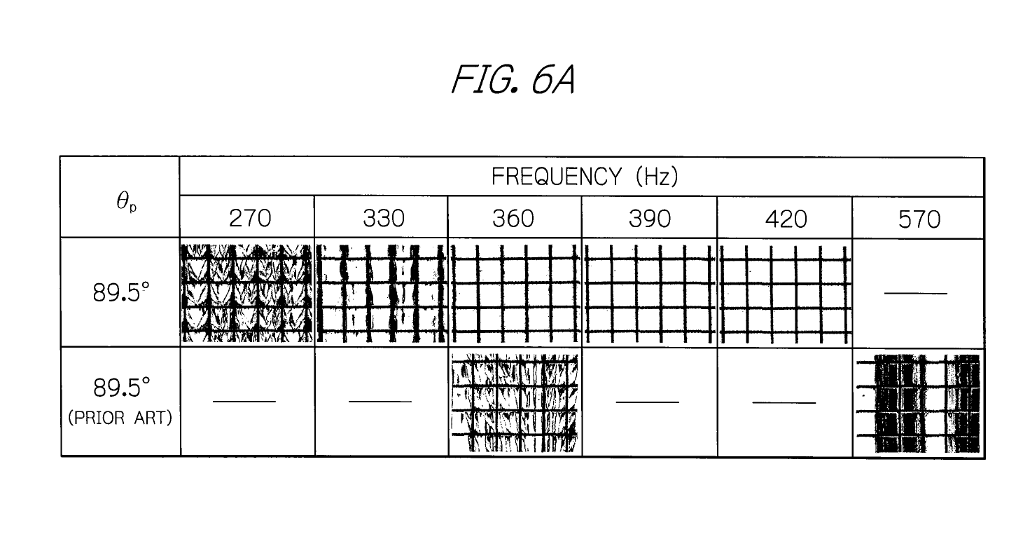

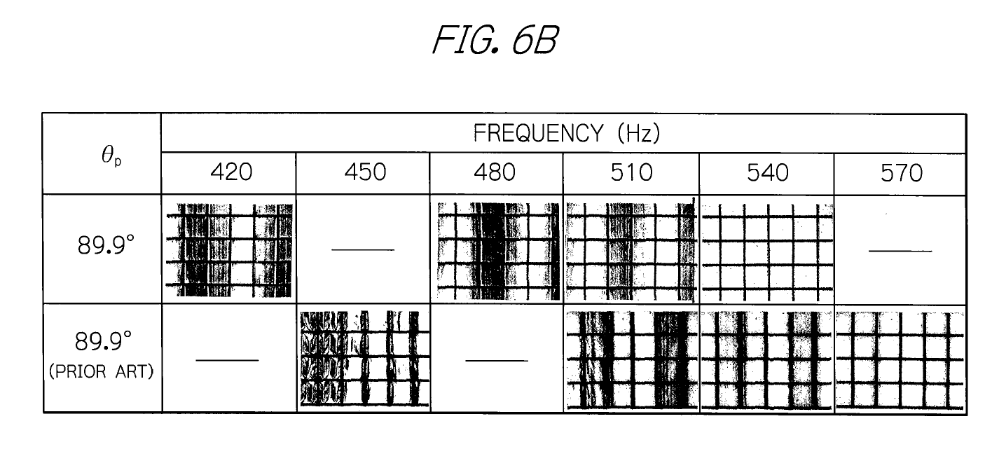

The experimental results of the simple matrix vertical alignment mode LCD device of FIGS. 4 and 5 driven by using the B-waveform at a 1/64 duty ratio and a bias of 1/9 are illustrated in FIGS. 6A and 6B.

As illustrated in FIG. 6A, when θₚ=89.5°, black shadow regions by the DMA phenomenon were visible for 330 Hz or less, while no black shadow regions were visible for 360 Hz or more, to realize an excellent transmission state of white dots. Thus, the DMA phenomenon was clearly suppressed as compared with the prior art simple matrix vertical alignment mode LCD device with no linear wall layers.

Also, as illustrated in FIG. 6B, when θₚ=89.9°, black shadow regions by the DMA phenomenon were visible for 510 Hz or less, while no black shadow regions were visible for 540 Hz or more, to realize an excellent transmission state of white dots. Thus, the DMA phenomenon was also clearly suppressed as compared with the prior art simple matrix vertical alignment mode LCD device with no linear wall layers.

Note that, when θₚ=89.5° or 89.9°, if the thickness T of the vertical alignment mode liquid crystal layer 3 is 4 μm and the height H of the linear wall layers LW₁₁, LW₁₂, . . . , LW₁ⱼ, . . . , LW_{1, n-1} is 2 μm (H=T/2), the DMA phenomenon was also suppressed. However, if the thickness T of the vertical alignment mode liquid crystal layer 3 is 4 μm and the height H of the linear wall layers LW₁₁, LW₁₂, . . . , LW₁ⱼ, . . . , LW_{1, n-1} is 1 μm (H=T/4), the DMA phenomenon was not suppressed.

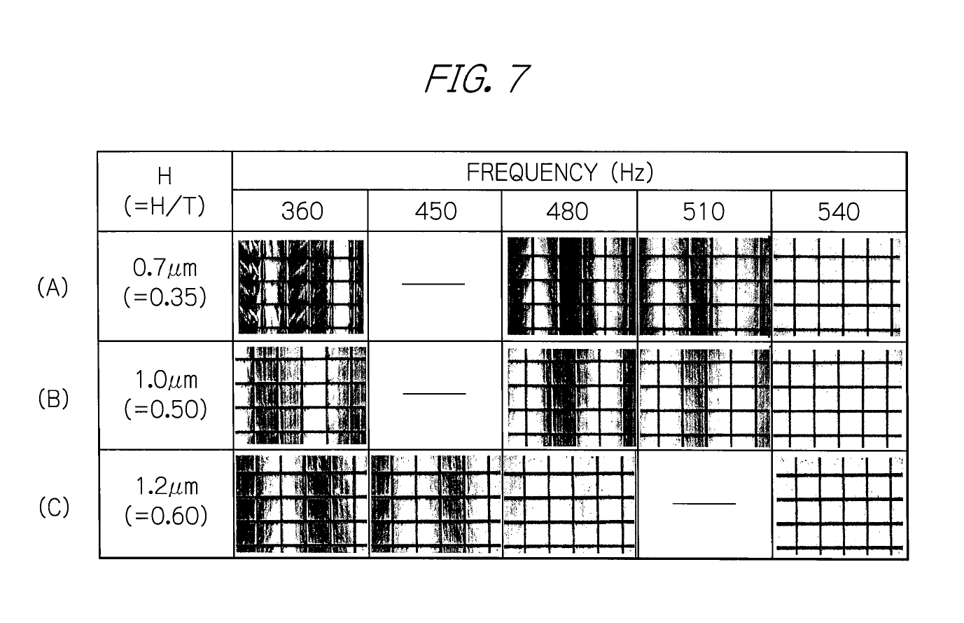

In more detail, as illustrated in FIG. 7 where θₚ=89.9°, in order to suppress the DMA phenomenon, the following is satisfied:

H≧T /2.

As illustrated in FIG. 7(A), when the thickness T of the vertical alignment mode liquid crystal layer 3 was 2 μm and the height H of the linear wall layers LW₁₁, LW₁₂, . . . , LW₁ⱼ, . . . , LW_{1, n-1} was 0.7 μm (H/T=0.35), black shadow regions by the DMA phenomenon were visible even at 540 Hz. Therefore, the DMA phenomenon was not so suppressed as compared with the case where H=T/2 as illustrated in FIG. 7(B).

As illustrated in FIG. 7(C), when the thickness T of the vertical alignment mode liquid crystal layer 3 was 2 μm and the height H of the linear wall layers LW₁₁, LW₁₂, . . . , LW₁ⱼ, . . . , LW_{1, n-1} was 1.2 μm (H/T=0.60), black shadow regions by the DMA phenomenon were visible even at 450 Hz, while no black shadow regions were visible for 480 Hz or more. The DMA phenomenon was so suppressed as compared with the case where H=T/2 as illustrated in FIG. 7(B).

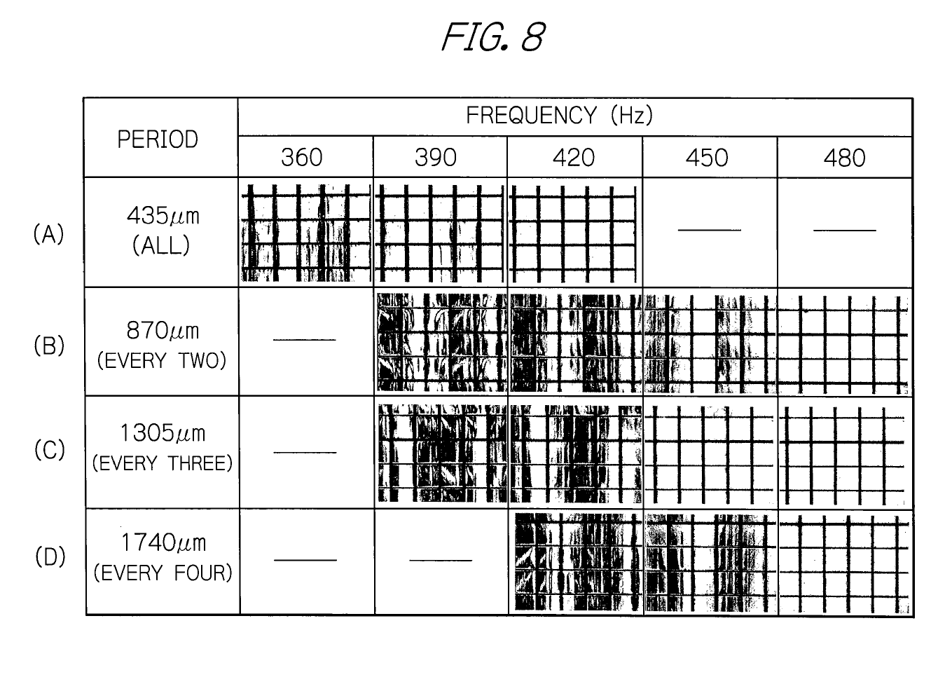

In the simple matrix vertical alignment mode LCD device of FIGS. 4 and 5, one linear wall layer is provided at each spacing of all the common electrodes COM₁, COM₂, . . . , COMⱼ, COMⱼ₊₁, . . . , COMₙ; however, one linear wall layer is provided at spacings of every two common electrodes, at spacings of every three common electrodes, . . . , as illustrated in FIG. 8. In FIG. 8, assume that the period of the common electrodes COM₁, COM₂, . . . , COMⱼ, COMⱼ₊₁, . . . , COMₙ is 435 μm. The experimental results where the period of the linear wall layers is 435 μm, i.e., one linear wall layer is provided for every common electrode, are illustrated in FIG. 8(A); the experimental results where the period of the linear wall layers is 870 μm, i.e. , one linear wall layer is provided for every two common electrodes, are illustrated in FIG. 8(B); the experimental results where the period of the linear wall layers is 1305 μm, i.e., one linear wall layer is provided for every three common electrodes, are illustrated in FIG. 8(C); and the experimental results where the period of the linear wall layers is 1740 μm, i.e., one linear wall layer is provided for every four common electrodes, are illustrated in FIG. 8(D). As illustrated in FIGS. 8(A), 8(B), 8(C) and 8(D), the larger the period of linear wall layers, the less the suppressing effect of the DMA phenomenon.

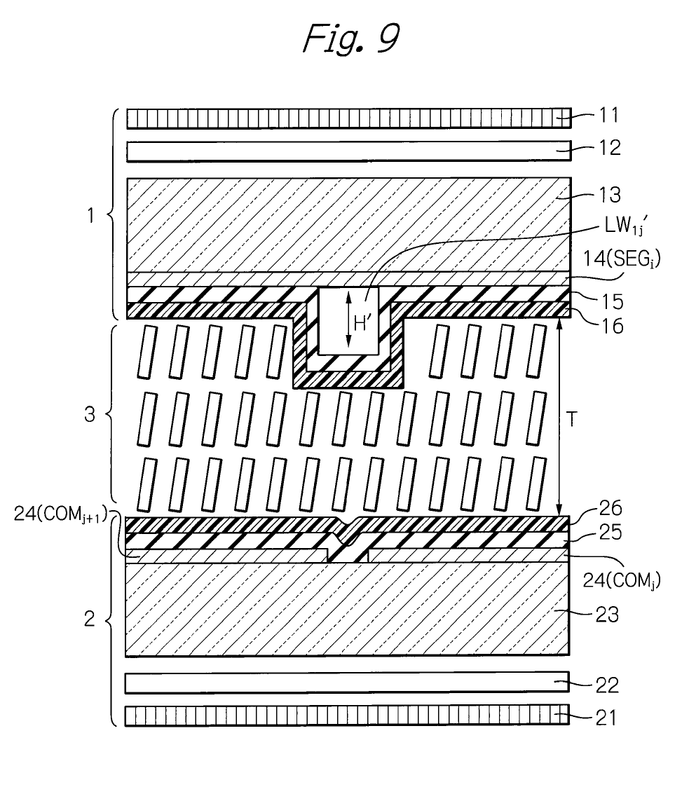

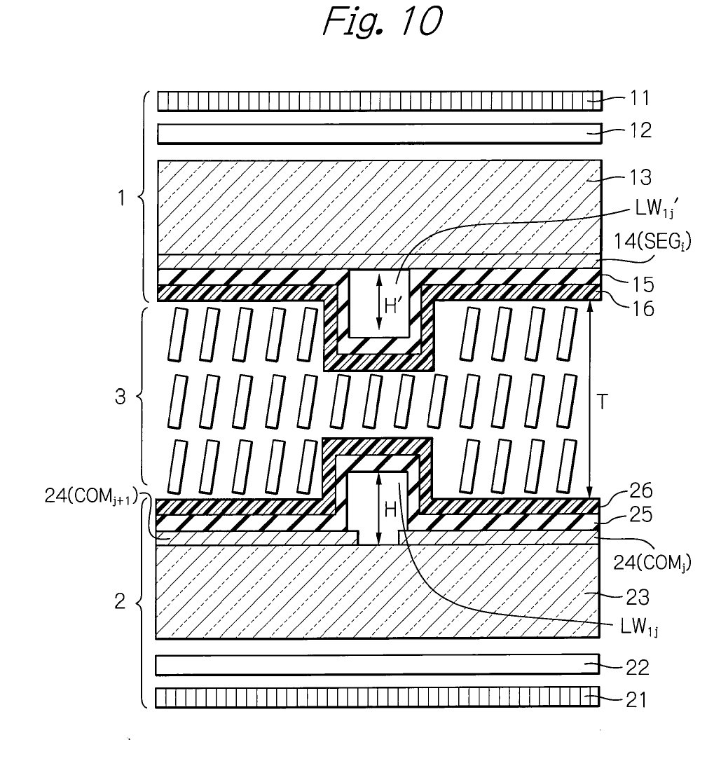

Instead of the linear wall layers LW₁₁, LW₁₂, LW₁ⱼ, . . . , LW_{1, n-1} provided on the side of the common electrode layer 24 as illustrated in FIG. 9, linear wall layers LW′₁₁, LW′₁₂, . . . , LW′₁ⱼ, . . . , LW′_{1, n-1} can be provided on the side of the segment electrode layer 14, thus exhibiting the same suppressing effect of the DMA phenomenon.

Further, in addition to the linear wall layers LW₁₁, LW₁₂, . . . , LW₁ⱼ, . . . , LW_{1, n-1} provided on the side of the common electrode layer 24 as illustrated in FIG. 9, linear wall layers LW′₁₁, LW′₁₂, . . . , LW₁ⱼ, . . . , LW′_{1, n-1} can be provided on the side of the segment electrode layer 14, thus exhibiting the same suppressing effect of the DMA phenomenon. In this case, the height H of the linear wall layers LW₁₁, LW₁₂, LW₁ⱼ, . . . , LW_{1, n-1} plus the height H′ of the linear wall layers LW′₁₁, KW′₁₂, . . . , LW′₁ⱼ, . . . , LW′_{1, n-1} are not smaller than half of the thickness T of the vertical alignment mode liquid crystal layer 3, i.e.,

H+H′≧T/2.

However, if H+H′=T, it is impossible to move liquid crystal between the upper structure 1 and the lower structure 2 during a liquid crystal injecting process for forming the vertical alignment mode liquid crystal layer 3. Therefore, in view of this, the following should be satisfied:

H+H′≦0.9T.

In this case, since the linear wall layers are provided on both sides of the segment electrode layer 14 and the common electrode layer 24 so that the height of each linear wall layer can be decreased, the portions of the vertical alignment layers 16 and 26 on the sidewalls of the linear wall layers, which portions are not subject to a rubbing alignment process, can be decreased. As a result, the director of liquid crystal within the dot is less affected by the linear wall layers.

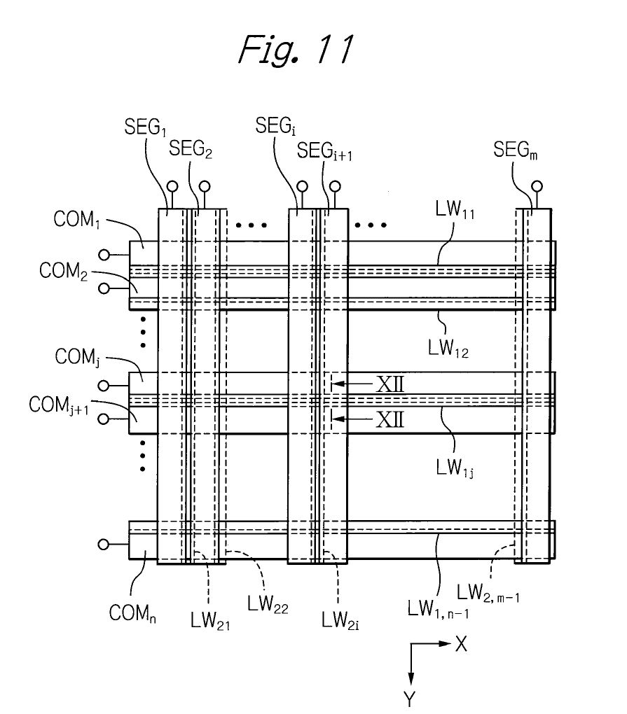

In FIG. 11, which illustrates a second embodiment of the single matrix vertical alignment mode LCD device according to the presently disclosed subject matter, in addition to the linear wall layers LW₁₁, LW₁₂, . . . , LWᵢⱼ, . . . , LW_{1, n-1} formed in parallel with the common electrodes COM₁, COM₂, . . . , COMⱼ, . . . , COMⱼ₊₁, . . . , COMₙ, of FIG. 4, linear wall layers LW₂₁, LW₂₂, . . . , LW₂ᵢ, . . . , LW_{2, m-1} are formed in parallel with the segment electrodes SEG₁, SEG₂, . . . , SEGᵢ, SEGᵢ₊₁, SEGₘ. In this case, the linear wall layers LW₂₁, LW₂₂, . . . , LW₂ᵢ, . . . , LW_{2, m-1} are formed at spacings between the segment electrodes SEG₁, SEG₂, . . . , SEGᵢ, SEGᵢ₊₁, . . . , to minimize the liquid crystal transmission ratio, i.e., the aperture ratio of the vertical alignment mode liquid crystal layer 3. Thus, the linear wall layers LW₁₁, LW₁₂, LWLW₁ⱼ. . . , LW_{i, n-1} and the linear wall layers LW₂₁, LW₂₂, . . . , LW₂ᵢ, . . . , LW_{2, m-1} form a grid pattern.

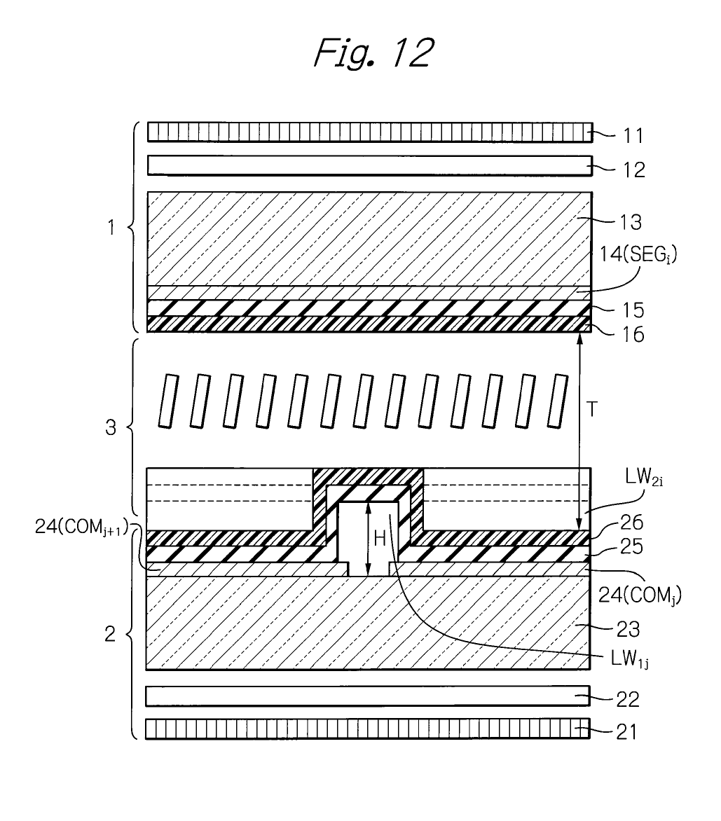

Referring to FIG. 12, which is a cross-sectional view taken along the line XII-XII in FIG. 11, the linear wall layer LW₂ᵢ, which is about 50 μm wide, is formed in spacings between the segment electrode SEG, and the segment electrode SEG,,, of the transparent segment electrode layer 14 whose spacing is about 30 μm, so that the linear wall layer LW₂ᵢ overlaps the segment electrode SEGᵢ and the segment electrode SEGᵢ₊₁. Also, a height H of the linear wall layer LW₂ᵢ is

H≧T/2.

The linear wall layers LW₂₁, LW₂₂, . . . , LW₂ᵢ, . . . , LW_{2, m-1} are made of the same material as that the linear wall layers LW₁₁, LW₁₂, . . . , LW₁ⱼ, . . . , LW_{1, n-1} and are formed simultaneously therewith.

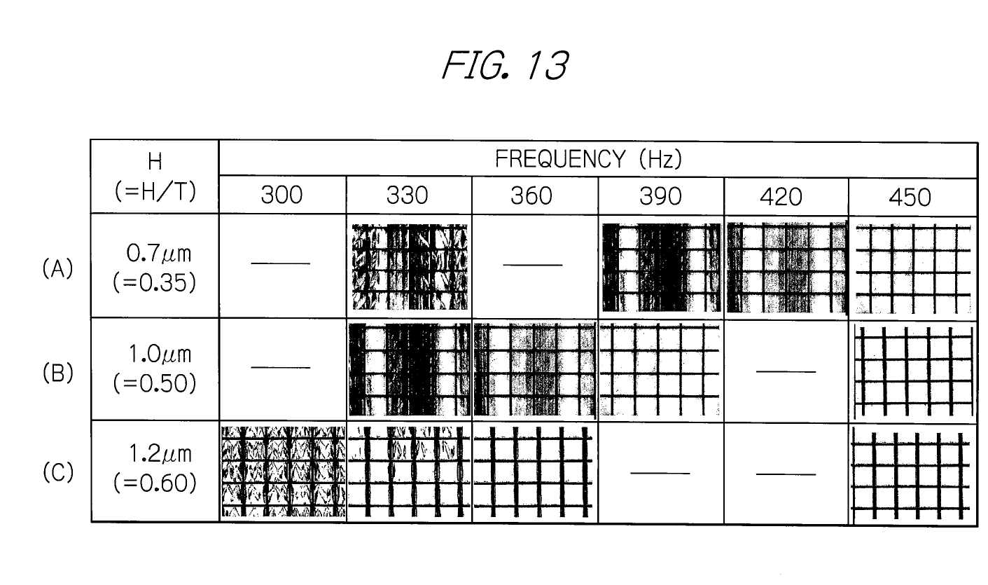

The experimental results of the simple matrix vertical alignment mode LCD device of FIGS. 11 and 12 driven by using the B-waveform at a 1/64 duty ratio and a bias of 1/9 are illustrated in FIG. 13 where θₚ=89.9°.

As illustrated in FIG. 13(A), when if the thickness T of the vertical alignment mode liquid crystal layer 3 was 2 μm and the height H of the linear wall layers LW₁₁, LW₁₂, . . . , LW₁ⱼ, . . . , LW_{1, n-1}, LW₂₁, LW₂₂, . . . , LW_{2, m'1}, . . . , was 0.7 μm (H/T=0.35), black shadow regions by the DMA phenomenon were visible for 420 Hz or less while no black shadow regions were visible for 450 Hz or more, to realize an excellent transmission state of white dots.

As illustrated in FIG. 13(B), when if the thickness T of the vertical alignment mode liquid crystal layer 3 was 2 μm and the height H of the linear wall layers LW₁₁, LW₁₂, . . . , LW₁ⱼ, . . . , LW_{1, n-1}, LW₂₁, LW₂₂, . . . , LW₂ᵢ, . . . , LW_{2, n-1} was 1 μm (H/T=0.50), black shadow regions by the DMA phenomenon were visible for 360 Hz or less while no black shadow regions were visible for 390 Hz or more, to realize an excellent transmission state of white dots.

As illustrated in FIG. 13(C), when the thickness T of the vertical alignment mode liquid crystal layer 3 was 2 μm and the height H of the linear wall layers LW₁₁, LW₁₂, . . . , LW₁ⱼ, . . . , LW_{1, n-1}, LW₂₁, LW₂₂, . . . , LW₂ᵢ, . . . , LW_{2, m-1} was 1.2 μm (H/T=0.60), black shadow regions by the DMA phenomenon were visible for 330 Hz or less, while no black shadow regions were visible for 360 Hz or more.

Thus, when comparing FIG. 13 with FIG. 7, the suppressing effect of the DMA phenomenon by providing the grid-patterned linear wall layers is exhibited over that by providing only the linear wall layers in parallel with the common electrodes COM₁, COM₂, . . . , COMⱼ, COMⱼ₊₁, . . . , COMₙ. This is because the grid-patterned linear wall layers does not only suppress the propagation of DMA phenomenon along the Y direction but also suppresses the propagation of DMA phenomenon along the X direction.

In the simple matrix vertical alignment mode LCD device of FIGS. 11 and 12, one linear wall layer is provided at each spacing of all the common electrodes COM₁, COM₂, . . . , COMⱼ, COMⱼ₊₁, . . . , COMₙ and the segment electrodes SEG₁, SEG₂, . . . , SEGᵢ, SEGᵢ₊₁, . . . , SEGₙ; however, one linear wall layer is provided in spacings of every two common electrodes, in spacings of every three common electrodes, . . . , in spacings of every two segment electrodes, in spacings of every three segment electrodes, . . . , although the suppressing effect of DMA phenomenon is inferior.

In FIG. 12, the linear wall layers LW₁₁, LW₁₂, . . . , LW₁ⱼ, . . . , LW_{1, n-1}, LW₂₁, LW₂₂, . . . , LW₂ᵢ, . . . , LW_{2, m-1} can be provided on the side of the segment electrode layer 14, thus exhibiting the same suppressing effect of the DMA phenomenon. Further, in addition to the linear wall layers LW₁₁, LW₁₂, . . . , LW₁ⱼ, . . . , LW_{1, n-1}, LW₂₁, LW₂₂, . . . , LW₂ᵢ, . . . , LW_{2, m-1} provided on the side of the common electrode layer 24, linear wall layers corresponding thereto can be provided on the side of the segment electrode layer 14, thus exhibiting the same suppressing effect of the DMA phenomenon. Also, in this case, the height H of the linear wall layers LW₁₁, LW₁₂, . . . , LW₁ⱼ, . . . , LW_{1, n-1}, LW₂₁, LW₂₂, . . . , LW₂ᵢ, . . . , LW_{1, m-1} plus the height H′ of the corresponding linear wall layers are not smaller than half of the thickness T of the vertical alignment mode liquid crystal layer 3, i.e.,

H+H′≧T/2.

However, if H+H′=T, it is impossible to move liquid crystal between the upper structure 1 and the lower structure 2 during a liquid crystal injecting process for forming the vertical alignment mode liquid crystal layer 3. Therefore, in view of this, the following should be satisfied:

H+H′≦0.9T.

Also, in this case, since the linear wall layers are provided on both sides of the segment electrode layer 14 and the common electrode layer 24 so that the height of each linear wall layer can be decreased, the portions of the vertical alignment layers 16 and 26 on the sidewalls of the linear wall layers, which portions are not subject to a rubbing alignment process, can be decreased. As a result, the director of liquid crystal within the dot is less affected by the linear wall layers.

In the above-described first embodiment, only the linear wall layers LW₁₁, LW₁₂, . . . , LW₁ⱼ, . . . , LW_{1, n-1}, (LW′₁₁, LW′₁₂, . . . , LW′₁ⱼ, . . . , LW′_{1, n-1}) in parallel with the common electrodes COM₁, COM₂, . . . , COMⱼ, COMⱼ₊₁, . . . , COMₙ are provided to suppress the propagation of DMA phenomenon along the Y direction, and only the linear wall layers LW₂₁, LW₂₂, . . . , LW₂ᵢ, . . . , LW_{2, m-1} in parallel with the segment electrodes SEG₁, SEG₂, . . . , SEGᵢ, SEGᵢ₊₁, . . . , SEGₘ can be provided to suppress the propagation of DMA phenomenon along the X direction.

Also, in the above-described first and second embodiments, when the linear wall layers are provided both on the side of the common electrode layer 24 and on the side of the segment electrode layer 14, the linear wall layers on one side can be transparent and the linear wall layers on the other side can be opaque (black matrix).

The presently disclosed subject matter can be applied to both a transmission-type LCD and a reflection-type

LCD. In the case of the reflection-type LCD, a reflective layer can be provided on an outer side of one of the polarizers, and a light incoming and outgoing can be carried out at the other polarizer.

It will be apparent to those skilled in the art that various modifications and variations can be made in the presently disclosed subject matter without departing from the spirit or scope of the presently disclosed subject matter. Thus, it is intended that the presently disclosed subject matter covers the modifications and variations of the presently disclosed subject matter provided they come within the scope of the appended claims and their equivalents. All related or prior art references described above and in the Background section of the present specification are hereby incorporated in their entirety by reference.

What is claimed is:

1. A simple matrix vertical alignment mode liquid crystal display device, comprising:
first and second substrates opposing each other;
a first electrode layer including a plurality of first electrodes, provided at an inner side of said first substrate;
a second electrode layer including a plurality of second electrodes, provided at an inner side of said second substrate;
a vertical alignment mode liquid crystal layer provided between said first and second substrates; and
a plurality of first linear wall layers, provided between said first and second substrates in parallel with said first electrodes.

2. The simple matrix vertical alignment mode liquid crystal display device as set forth in claim 1, wherein one of said first linear wall layers is provided for a predetermined number of said first electrodes.

3. The simple matrix vertical alignment mode liquid crystal display device as set forth in claim 1, wherein each of said first linear wall layers is placed in spacings of said first electrodes.

4. The simple matrix vertical alignment mode liquid crystal display device as set forth in claim 1, wherein said first linear wall layers are provided on the side of one of said first and second substrates.

5. The simple matrix vertical alignment mode liquid crystal display device as set forth in claim 4, wherein a height of said first linear wall layers is not smaller than half of a height of said vertical alignment mode liquid crystal layer.

6. The simple matrix vertical alignment mode liquid crystal display device as set forth in claim 1, wherein said first linear wall layers are provided on the sides of both of said first and second substrates.

7. The simple matrix vertical alignment mode liquid crystal display device asset forth in claim 6, wherein a total height of said first linear wall layers on the sides of both of said first and second substrates is not smaller than half of a height of said vertical alignment mode liquid crystal layer.

8. The simple matrix vertical alignment mode liquid crystal display device as set forth in claim 1, further comprising:
a plurality of second linear wall layers, provided between said first and second substrates in parallel with said second electrodes.

9. The simple matrix vertical alignment mode liquid crystal display device as set forth in claim 8, wherein one of said second linear wall layers is provided for a predetermined number of said second electrodes.

10. The simple matrix vertical alignment mode liquid crystal display device as set forth in claim 8, wherein each of said second linear wall layers is placed in spacings of said second electrodes.

11. The simple matrix vertical alignment mode liquid crystal display device as set forth in claim 8, wherein said first and second linear wall layers are provided on the side of one of said first and second substrates.

12. The simple matrix vertical alignment mode liquid crystal display device as set forth in claim 11, wherein a height of each of said first and second linear wall layers is not smaller than half of a height of said vertical alignment mode liquid crystal layer.

13. The simple matrix vertical alignment mode liquid crystal display device as set forth in claim 8, wherein said first linear wall layers are provided on the sides of both of said first and second substrates, and said second linear wall layers are provided on the side of the other of said first and second substrates.

14. The simple matrix vertical alignment mode liquid crystal display device as set forth in claim 13, wherein a total height of said first and second linear wall layers is not smaller than half of a height of said vertical alignment mode liquid crystal layer.

15. The simple matrix vertical alignment mode liquid crystal display device as set forth in claim 1, wherein said first electrodes comprise segment electrodes, and said second electrodes comprise common electrodes.

16. The simple matrix vertical alignment mode liquid crystal display device as set forth in claim 1, wherein said first electrodes comprise common electrodes, and said second electrodes comprise segment electrodes.

17. The simple matrix vertical alignment mode liquid crystal display device as set forth in claim 1, wherein said first linear wall layers comprise ultraviolet ray hardening resin.

18. The simple matrix vertical alignment mode liquid crystal display device as set forth in claim 1, wherein said second linear wall layers comprise ultraviolet ray hardening resin.
